(19) United States
(12) Patent Application Publication
(10) Pub. No.: US 2010/0297441 A1
(43) Pub. Date: Nov. 25, 2010

(54) Preparation of fibers from a supported array of nanotubes

(75) Inventor: Yuntian T. Zhu, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: The Regents of the University of California

(21) Appl. No.: 11/051,007

(22) Filed: Feb. 4, 2005

Related U.S. Application Data
(60) Provisional application No. 60/620,088, filed on Oct. 18, 2004.

(51) Int. Cl. D01F 9/12; C08K 3/04; D01F 9/32; D01D 5/00

(52) U.S. Cl. 428/370; 423/447.1; 428/371; 264/103; 524/496; 425/66; 977/742; 977/842

(57) ABSTRACT

Fibers are spun from a supported array of nanotubes. Fibers are spun using a spinning shaft with, for example, a hook shaped end that contacts the supported nanotubes and twists some of them around each other to begin the fiber. As the twisted nanotubes detach from the support, the shaft moves away from and along the supported array in a controlled direction and at a controlled speed as it spins to twist and detach additional nanotubes from the support and extend the length of the fiber. If the array is pretreated with a dilute polymer solution, excess solution is squeezed out of the growing fiber during spinning, and the polymer may be cured at elevated temperature to provide a strong nanotube composite fiber.

### RELATED CASES

This application claims the benefit of U. S. Provisional application Ser. No. 60/620,088 filed Oct. 18, 2004, incorporated by reference herein.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates generally to preparing fibers and more particularly to a method of spinning long fibers from a supported array of nanotubes.

### BACKGROUND OF THE INVENTION

Individual carbon nanotubes (CNTs) are at least one order of magnitude stronger than any other known material. CNTs with perfect atomic structures have a theoretical strength of about 300 GPa [1]. In practice carbon nanotubes do not have perfect structures. However, CNTs that have been prepared have a measured strength of up to about 150 GPa, and the strength may improve upon annealing. For comparison, Kevlar fibers currently used in bullet-proof vests have a strength of only about 3 GPa, and carbon fibers used for making space shuttles and other aerospace structures have strengths of only about 2-5 GPa [2].

CNTs have to be bonded together in order to structurally utilize their strength. The most common approach has been to mix CNTs with a polymer binder and then spin a CNT composite fiber from the mixture. Thus far, this approach has not been very successful and such fibers are not very strong. Microstructural analysis indicates that the CNTs of these composite fibers are misaligned and/or tangled. This misalignment and entanglement lowers the volume fraction and packing density of the CNTs and the load carrying efficiency of the corresponding composite fiber. The relatively low volume fraction of CNTs in these fibers limits the strength of the composite fiber. One problem with using a polymer to bind CNTs together relates to the weak bonding observed thus far between CNTs and the polymer binder. Controlling the polymer/CNT interface chemically, which many research groups attempt to do, is a nontrivial task. The best carbon nanotube/polymer composite fibers to date have been prepared with a 60 percent volume fraction of CNTs and have a strength of only 1.8 GPa [3]. These composite fibers utilize only about 2 percent of the potential strength of the CNTs, assuming the strength of individual CNT is 150 GPa.

There remains a need for long carbon fibers with improved strength.

Accordingly, an object of the present invention is to provide composite fibers of carbon nanotubes and polymer binder with improved strength.

Another object of the present invention is to provide a method for preparing composite fibers of carbon nanotubes and polymer with improved strength.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

In accordance with the purposes of the present invention, as embodied and broadly described herein, the present invention includes a method for preparing a fiber that involves spinning a fiber from a supported array of nanotubes. The method may involve moving an end of a spinning shaft to the supported array of nanotubes to make contact with supported nanotubes from the array and twist at least some of them around each other to begin the fiber. As the twisted nanotubes detach from the support, the spinning shaft is moved relative to the supported array so that additional supported nanotubes from the array twist around the growing fiber and extend the length of the growing fiber. The array can be coated with a polymer solution before spinning; during spinning, excess solution is squeezed out of the fiber, and afterward the polymer can be cured at elevated temperature.

The invention also includes a composite fiber prepared by twisting and detaching nanotubes from a supported array of nanotubes. The nanotubes are detached and twisted around each other by moving an end of a spinning shaft to the supported array of nanotubes to make contact with supported nanotubes from the array and twisting at least some of them around each other to begin the fiber, and as the twisted nanotubes detach from the support, moving the spinning shaft relative to the supported array so that additional supported nanotubes from the array twist around the growing fiber and extend the length of the growing fiber. The array can be coated with a polymer solution before spinning; during spinning, excess solution is squeezed out of the fiber, and the polymer can be cured at elevated temperature.

The invention also includes. an apparatus for spinning fibers. The apparatus includes a supported array of nanotubes, a shaft, and at least one motor for engaging the shaft to spin at a controlled angular velocity so that the spinning shaft can pull a fiber from the nanotube array at a controlled speed and angular velocity. One end of the shaft is sticky and/or roughened and/or shaped like a hook or other structure capable of gathering nanotubes from the supported array. Either or both the spinning shaft and supported array can move in a controlled direction (horizontally, vertically, or at any angle) and be oriented at any angle relative to one another, so that the array can move away from the shaft in a controlled direction and at a controlled speed when supported nanotubes detach from array and become part of a spun fiber.

### BRIEF DESCRIPTION OF THE DRAWINGS

The accompanying drawings, which are incorporated in and form a part of the specification, illustrate the embodiment(s) of the present invention and, together with the description, serve to explain the principles of the invention. In the drawings:

FIG. 1 shows a scanning electron micrograph image of an aligned substantially parallel array of carbon nanotubes prepared by chemical vapor deposition (CVD) that may be used to prepare fibers of the invention.

FIG. 2 shows a flow diagram summarizing various steps of the invention; and

FIG. 3 shows a schematic representation of spinning a fiber from supported carbon nanotubes, where ‘ω’ is the spinning rate and ‘v’ is the pulling speed; and

FIGS. 4a-c show schematic representations of an embodiment method for preparing a fiber of an array of supported nanotubes that are substantially aligned and untangled. In FIG. 4a, a hooked end of a spinning shaft is above a supported array of nanotubes. In FIG. 4b, the hooked end makes contact with nanotubes from the supported array and begins to twist them around the hooked end. In FIG. 4c, the array moves along an axis relative to the spinning shaft as nanotubes are twisting around each other and detaching from the supported array to begin the fiber.

### DETAILED DESCRIPTION

This invention relates to the preparation of fibers and, more particularly, involves a method and apparatus for spinning nanotubes from a supported array of nanotubes. The invention spirally aligns the carbon nanotubes into a fiber from the supported array. An advantage of spinning the fiber from the supported array is that the nanotubes from the array are untangled and generally aligned relative to one another before they are spun into a fiber. The spinning process spirally aligns the nanotubes, and this spirally aligned arrangement provides the composite fiber with high strength. Composite fibers of this invention have a rope like structure that is made strong by twisting the carbon nanotubes together and around each other.

The nanotubes of the array may be coated with a polymer solution before they are spun into fibers. The spinning process spirally aligns the polymer-coated nanotubes, and when the nanotubes are carbon nanotubes, the resulting fiber has a high volume fraction (60 percent of nanotubes, and higher), and the twisting improves the bonding between the nanotubes and the polymer. The composite fibers of this invention may be prepared by spinning together nanotubes (carbon nanotubes, boron nanotubes, BCN nanotubes, tungsten sulfide nanotubes, Y2O3:Eu nanotubes, Mn doped Ge nanotubes, for example) from a substantially aligned and untangled array.

Carbon nanotube arrays where the nanotubes have lengths of about 1 to 2 millimeters or longer have been prepared by catalytic chemical vapor deposition (CVD) [4]. Multi-wall carbon nanotube arrays prepared by, for example, decomposition of a mixture of ferrocene and xylene in a quartz tube reactor grow at a rate of about 50 μm/min. Arrays of carbon nanotubes having lengths of 1 to 2 millimeters, and longer, may also be prepared using a solution of FeCl₃ in ethanol (C₂H₅OH). Ethanol, which has been reported to be the cleanest source of carbon for CNT [7], might produce carbon nanotubes with fewer defects and smaller diameters, and these nanotubes may be used with this invention to produce fibers with higher strength.

The spinning approach has several advantages over a drawing approach. One advantage relates to the relative ease a spinning process provides for preparing fibers compared to a drawing process.

Another advantage of the spinning approach versus the drawing approach relates to the helical orientation of the nanotubes that results from a spinning the nanotubes and twisting them around each other. This helical orientation contributes to improving load transfer because the twisted nanotubes can squeeze radially against each other when the composite fiber is under load, which increases the bonding strength and consequently load-transfer efficiency. Untwisted carbon nanotubes/polymer composite fibers prepared by drawing are not strong fibers [5], presumably because the nanotube-polymer interface is slippery, making it difficult to transfer load onto the nanotubes.

Another advantage of spinning process of this invention is that the twisting squeezes out excess polymer so that individual CNTs can be closely spaced together. This close spacing increases the CNT volume fraction of the composite fiber.

Another advantage of the invention relates to using a substantially aligned array of carbon nanotubes to prepare the fiber composite. The alignment of the nanotubes prior to spinning guarantees alignment in the spun composite fiber.

Composite fibers of this invention could be used for a variety of applications. These fibers could be used to prepare superior laminates, woven textiles, and other structural fiber composite articles. Fiber composites of this invention could be used to prepare strong and light armor for aircraft, missiles, space stations, space shuttles, and other high strength articles. The reduced weight would allow aircraft and projectiles to fly faster and for longer distances. These features are also important for spacecraft for future space missions (to the moon and to Mars, for example), where high strength and lightweight features of the composite fibers are very important.

Another advantage of this invention becomes apparent when metallic carbon nanotubes are used to prepare the composite fiber. Metallic carbon nanotubes have been shown to be about a thousand times more electrically conductive than copper [6]. Thus, composite fibers of this invention prepared using precursor metallic carbon nanotubes would not only be very strong but also highly electrically conductive.

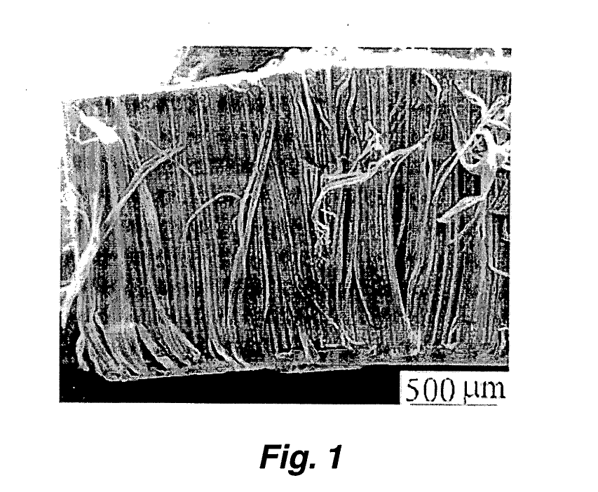

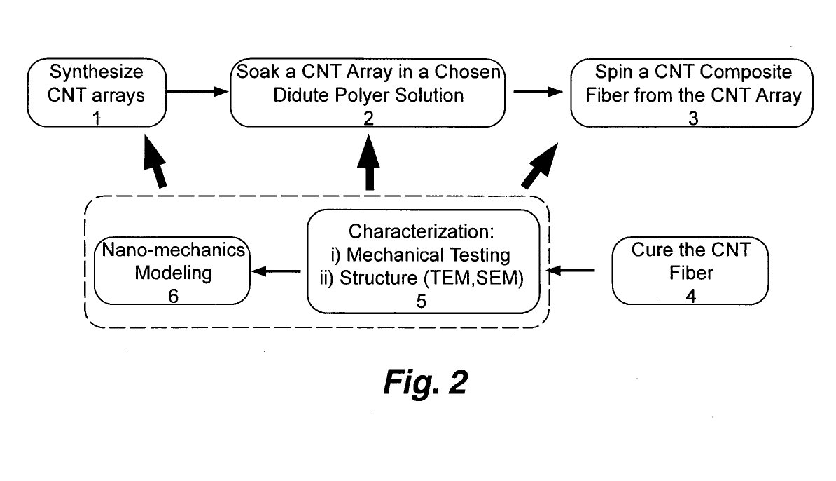

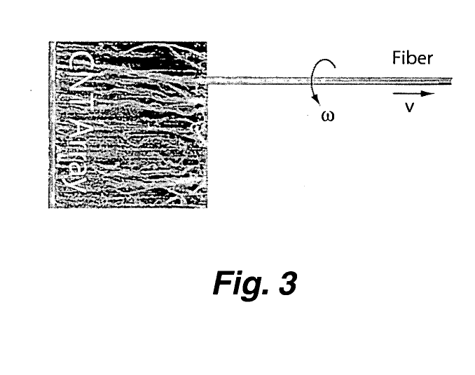

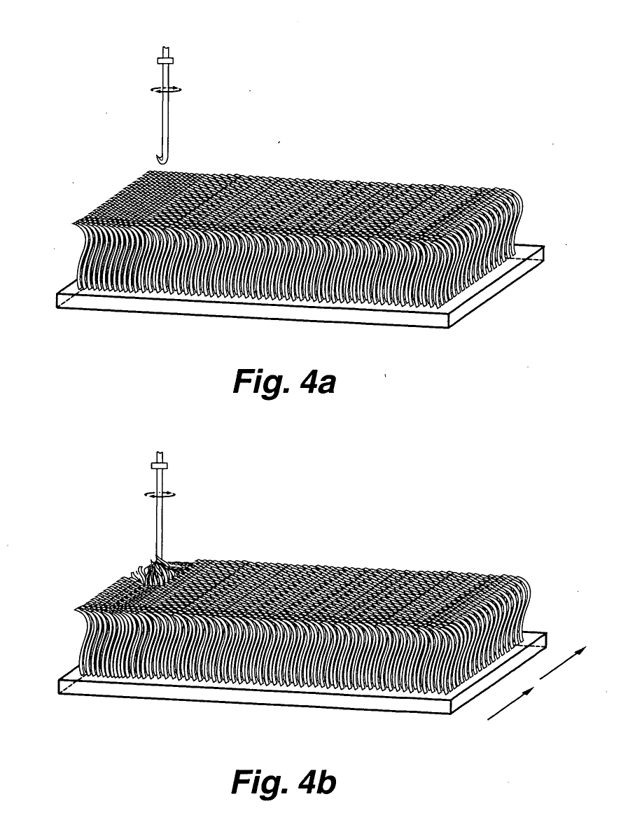

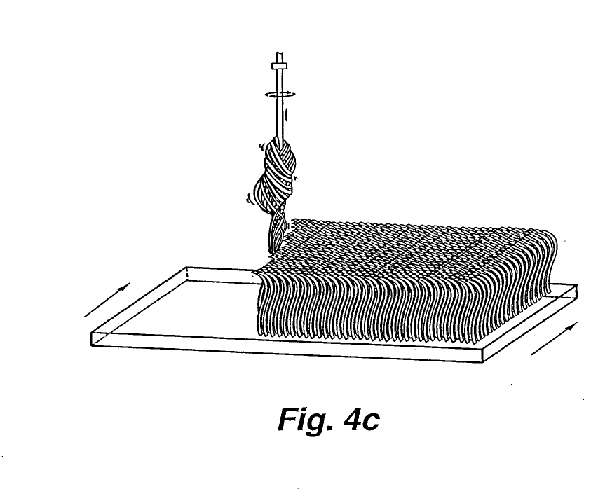

Composite fibers of this invention are prepared using a substantially parallel, aligned carbon nanotube array of the type illustrated in FIG. 1, FIG. 3, and FIG. 4. Arrays like these can be used after they are prepared, or they can be coated with a dilute solution of polymer by, for example, immersing the nanotube array in a polymer solution in a bicker, and then ultrasonically vibrating the immersed array to promote wetting. Polymer solutions that have been used in the past to prepare carbon nanotube-polymer composites could be used with this invention and include, but are not limited to, polystyrene dissolved in toluene [8], low-viscosity liquid epoxy [6], poly(methyl methacrylate) (PMMA) dissolved in PMF [9], polyvinyl alcohol (PVA) in water [10], and poly(vinyl pyrrolidone) (PVP) in water [10].

The next step involves spinning a fiber from the array of supported nanotubes. FIG. 3 schematically shows the spinning process. As FIG. 3 shows, the fiber spins at a rate of ω while being pulled at a speed of v. The spinning parameters ω and v likely have an effect on the microstructural characteristics (e.g. the fiber diameter, the helix angle of individual CNTs in the fiber, and the like) of the resulting composite fiber. The spinning parameters can be adjusted to optimize the fiber structure for highest strength.

FIG. 4a-c shows a more detailed schematic representation of an embodiment method for preparing a fiber of an array of supported nanotubes that are substantially aligned and untangled. The nanotubes may be carbon nanotubes, or any type of nanotube for which a supported array can be prepared. In FIG. 4a, a hooked end of a spinning shaft is shown above a supported array of nanotubes. The scale of FIG. 4a-c is not meant to indicate that the width of the shaft is about the same as the width of the nanotubes. In practice, nanotubes will be narrower than the spinning shaft. Also, the hooked end can be replaced with other structures that can gather perhaps tens, hundreds, thousands, tens of thousands, or hundreds of thousands of nanotubes. An adhesive can be used instead of, or with, the hooked end for nanotubes to stick on. In FIG. 4b, the shaft has moved near enough to the array so that the hooked end makes contact with nanotubes from the supported array and, as the shaft turns, begins to twist them around the hooked end. Many thousands of nanotubes are likely twisted together at the beginning. In FIG. 4c, the fiber begins to grow as the array moves vertically away from the spinning shaft and along a horizontal axis relative to the spinning shaft as the shaft spins and nanotubes are twisting around each other and detaching from the supported array. The relative movement of the spinning shaft and the array may be accomplished by adjusting the vertical and horizontal position of the spinning shaft and/or the array. The array can also move along another horizontal axis relative to the spinning shaft, and away from the spinning shaft, so that additional nanotubes from the array can twist around the growing fiber to extend the length of the fiber.

After the fiber has reached a desired length, the spinning process is stopped and the ends of the fiber may be treated with an adhesive, pinched, or otherwise treated so that the spun fiber does not unravel.

The as-spun fiber can be stretched to improve alignment of the nanotubes.

For the case involving polymer-coated nanotubes, after spinning and stretching, solvent is evaporated and the polymer is cured at an appropriate temperature. Detailed treatment parameters depend on the specific polymer and solvent that are used during the preparation. A vacuum oven may be used for solvent removal and curing.

The cured composite fiber of the invention can be evaluated in tension to obtain the strength, the dependency of the strength on the length (i.e size effect), the Young's modulus, the ductility, and other properties. The fracture surface of the composite fiber may be examined using Scanning Electron Microscopy (SEM) to investigate the failure mode in order to evaluate the strength of the CNT/polymer interface. Transmission electron microscopy (TEM) may be used to examine individual CNT arrangements in the composite fiber and the CNT/matrix interface.

In summary, this invention relates to carbon nanotube composite fibers that are expected to be many times stronger (10-40 GPa) than any currently available structural materials, including carbon fibers and Kevlar, which are currently the materials of choice for space shuttles and personal armors. The composite fibers of this invention are different from CNT fibers prepared by other methods in that CNTs are twisted around each other spirally with near perfect alignment and high CNT volume fraction. The fibers can be spun continuously without apparent length limit, and spooled onto a spindle or wound onto a roller.

The foregoing description of the invention has been presented for purposes of illustration and description and is not intended to be exhaustive or to limit the invention to the precise form disclosed, and obviously many modifications and variations are possible in light of the above teaching.

The embodiment(s) were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

### REFERENCES

The following references are incorporated by reference herein.

1. B. G. Demczyk, Y. M. Wang, J. Cunnings, M. Hetman, W. Han, A. Zettl, and R. O. Ritchie, Mater. Sci. Eng. A334 (2002) pp. 173-178.

2. Concise Encyclopedia of Composite Materials, edited by A. Kelly, Pergamon, Oxford, UK (1995) pp. 42, 50, 94.

3. A. B. Dalton, S. Collins, E. Munoz, J. M. Razal, V. H. Ebron, J. P. Ferraris, J. N. Coleman, B. G. Kim, and R. H. Baughman, Nature 423 (2003) p. 703.

4. X. Zhang, A. Cao, B. Wei, Y. Li, J. Wei, C. Xu, and D. Wu, Chem. Phys. Left. 362 (2002) pp. 285-290.

5. K. Jiang, Q. Li, and S. Fan, Nature 419 (2002) p. 801.

6. D. Penumadu, A. Dutta, G. M. Pharr, and B. Files, J. Mater. Res. 18 (2003) pp. 1849-1853.

7. S. Maruyama, R. Kojima, Y. Miyauchi, S. Chiashi, and M. Kohno, Appl. Phys. Left. 360 (2002) pp. 229-234.

8. B. Safadi, R. Andrews, and E. A. Grulke, J. Applied Polymer Sci. 84 (2002) pp. 2660-2669.

9. R. Haggenmueller, H. H. Gommans, A. G. Rinzler, J. E. Fischer, and K. I. Winey, Chem. Phys. Left. 330 (2000) pp. 219-225.

10. J. N. Coleman, W. J. Blau, A. B. Dalton, E. Munoz, S. Collins, B. G. Kim, J. Razal, M. Selvidge, G. Vieiro, and R. H. Baughman, Appl. Phys. Left. 82 (2003) pp. 1682; and M. Cakek, J. N. Coleman, V. Barron, K. Hedicke, and W. J. Blau, Appl. Phys Lett 81 (2002) pp. 5123-5125.

1. A method for preparing a fiber of spirally-aligned nanotubes from a supported array of nanotubes, comprising moving an end of a spinning shaft toward the supported array of nanotubes to make contact with nanotubes from the array and twist at least some of them around each other to begin the fiber of spirally-aligned nanotubes, and as the nanotubes detach from the support, moving the spinning shaft relative to the supported array so that additional supported nanotubes from the array continue to twist around the growing fiber and extend the length of the growing fiber of spirally-aligned nanotubes.

2. (canceled)

3. The method of claim 1, wherein the nanotubes comprise carbon nanotubes.

4. The method of claim 1, further comprising depositing a solution of polymer on the supported array of nanotubes before forming the fiber of spirally aligned nanotubes.

5. The method of claim 4, further comprising removing excess polymer solution from the fiber of spirally aligned nanotubes and then curing the polymer.

6. The method of claim 5, wherein curing the polymer comprises heating the polymer at an elevated temperature sufficient to cure the polymer.

7. A fiber of spirally aligned nanotubes and polymer, said fiber prepared by a method comprising:
depositing a solution of polymer on a supported array of nanotubes, and thereafter
moving an end of a spinning shaft to the supported array of nanotubes to make contact with supported nanotubes from the array and twisting at least some of them around each other to begin the fiber of spirally aligned nanotubes, and as the nanotubes detach from the support,
moving the spinning shaft relative to the supported array so that additional supported nanotubes from the array continue to twist around the growing fiber and extend the length of the growing fiber of spirally aligned nanotubes and polymer.

8-9. (canceled)

10. The fiber of claim 7, wherein the method further comprises removing excess polymer solution from the fiber of spirally aligned nanotubes and curing the polymer.

11. The fiber of claim 7, wherein the nanotubes comprise carbon nanotubes.

12. (canceled)

13. A fiber composite comprising spirally aligned nanotubes and a polymer binder.

14. A fiber composite consisting essentially of spirally aligned nanotubes and a cured polymer binder.

15. An apparatus for preparing a fiber of spirally-aligned nanotubes, comprising a supported array of nanotubes, a shaft, and at least one motor for engaging the shaft to spin the shaft at a controlled angular velocity, the shaft comprising an end for gathering nanotubes from the supported array when the motor engages the shaft and twisting the nanotubes around each other when the shaft spins, the array capable of moving away from the shaft in a controlled direction and at a controlled speed when supported nanotubes detach from array and become part of a fiber of spirally-aligned nanotubes.
